(19) United States
(12) Patent Application Publication
(10) Pub. No.: US 2006/0118389 A1
(43) Pub. Date: Jun. 8, 2006

(54) Spiked conveyor belt

(76) Inventor: Bruce Hyndman Henley, INVERCARGILL (NZ)

Correspondence Address: MCCORMICK, PAULDING & HUBER LLP, CITY PLACE II, 185 ASYLUM STREET, HARTFORD, CT, 06103, US

(21) Appl. No.: 10/539,253

(22) PCT Filed: Dec. 15, 2003
(86) PCT No.: PCT/NZ03/00275

§ 371 Date: Jun. 16, 2005

(30) Foreign Application Priority Data
Dec. 16, 2002 (NZ) 523304

(51) Int. Cl. B65G 17/46

(52) U.S. Cl. 198/692; 198/853; 198/688.1

(57) ABSTRACT

A module for a spiked conveyor belt and a spiked conveyor belt made from these modules, the modules being made of a flexible material and having a substantially flat first surface from which a plurality of space pins protrude; one end of each pin extends from the first surface at an angle of about 60° to the surface; the other end of the pin is mounted in a rib formed on a second surface of the module, the second surface also providing means for hinging the modules together.

### TECHNICAL FIELD

The present invention relates to an improved brattice belt.

As used herein, the term “brattice belt” means an elevator conveyor belt which is provided with a plurality of spaced protrusions and which typically is used for the transport of fibrous materials (such as wool, wood fibre, shredded paper, metal turnings and the like) from a loosely packed bulk supply.

### BACKGROUND ART

There are a number of existing types of brattice belt currently in use; these are described briefly with reference to accompanying FIGS. 1-3.

FIG. 1 shows, in plan view, a design of brattice belt which has been used for many years. The brattice belt 2 comprises two parallel roller chains 5,6 with a series of parallel, spaced, stainless steel laths 7 bolted between them, with the laths extending perpendicular to the length of the chains 5,6. Each of the laths 7 carries a series of stainless steel pins 8 spaced along the length of the lath and welded to the lath so as to protrude from the upper surface of the lath at an acute angle to the lath.

In use, the belt 2 extends between two spaced pairs of drive sprockets (not shown) which engage the chains 5,6 to drive the belt. As the belt is driven, a mass of loose fibrous material, (e.g. wool) is dumped on one end of the belt and smaller clumps of fibres are teased out of the mass by the pins 8 and carried up to the other end of the belt.

This design is efficient in that the chains 5,6 can flex sufficiently to give a close contact with the drive sprockets. However, the belt, being all metal, is heavy, and a further drawback is that because the pins are secured by welding, if there is any damage to the belt a complete lath must be replaced. The roller chains require lubrication and this means that the oil or other lubrication medium tends to spread on to the materials being transported by the brattice belt.

FIG. 2 shows a side view of a more recent design of brattice belt. In this design, a continuous flat flexible belt 9 carries a series of spaced rigid plastic laths 10 which are bolted to the belt by bolts 11; the laths 10 extend perpendicular to the direction of movement of the belt. Along the length of each lath 10, a series of spaced stainless steel pins 12 are driven through the thickness of the lath to extend at an acute angle to the surface of the belt.

This brattice belt functions in the same general manner as that described with reference to FIG. 1, except that the drive sprockets engage the gaps 13 between adjacent laths 10 to drive the belt.

This design has the advantage that it does not require lubrication, but the construction is expensive and once the belt is fully assembled, is relatively inflexible. Further, if any part of the belt is damaged, the whole belt must be repaired or replaced.

FIG. 3 shows a side view of part of a third type of brattice belt, sold under the trade mark “Flextrak”. In this design, a brattice belt is assembled from a series of modules 14 which are moulded from a rigid polymer and are hinged together using moulded-in pins 15. Each pin 15 engages a hook 15a moulded on one end of the module, to link adjacent modules together.

Each module 14 is formed with a cavity 16 on its underside, which can engage a drive sprocket 17, only part of which is shown. Each module 14 provides a protruding boss 18 on its upper surface; a stainless steel pin 19 is moulded into the boss 18 so as to protrude from the upper surface of the boss at an acute angle to the plane of the belt when assembled.

This design is easily assembled, and if any damage occurs to the belt, the individual modular sections can easily be replaced. However, the design has a number of disadvantages:—
the boss 18 greatly reduces the effective length of the pin 19 and thus reduces the ability of the pin to pick up fibrous material;
the boss 18 tends to catch material being transported, and to retain such material, since any material caught by the boss does not slide off the boss as readily as off the pins.
the modules are rigid, and although the belt can pivot at the joints between the modules, overall the belt is rather a rigid construction which does not engage the drive sprockets efficiently.
the rigidity of the modules means that if a pin is overloaded, all the load is on the pin, which may break.

### DISCLOSURE OF INVENTION

It is therefore an object of the present invention to provide a brattice belt module and a brattice belt which overcome the above described disadvantages of the existing designs.

The present invention provides a module for a brattice belt, said module being made of flexible material and providing a substantially flat first surface from which protrude a plurality of spaced pins, one end of each pin extending from said first surface with the longitudinal axis of the pin at an acute angle to the plane of the first surface, the other end of each pin being mounted in a rib formed on a second surface of the module opposite to said first surface, said second surface also providing means for hingedly securing modules together, said securing means being spaced from said rib.

The present invention further provides a brattice belt made of the above modules, the modules being hinged together to form a continuous loop.

Preferably, the module is made of a polyurethane elastomer with rubber like properties and is very flexible. Typically, the module would be sufficiently flexible to allow a pin to deflect through at least 10°, preferably 20°-30°, relative to the plane of the belt, without any damage to the module material.

Preferably, the module is substantially rectangular in plan, and securing means in the form of series of spaced bosses are provided along each of two opposed edges.

### BRIEF DESCRIPTION OF DRAWINGS

By way of example only, a preferred embodiment of the present invention is described in detail with reference to the accompanying drawings, in which:—

FIG. 4 is a plan view of the brattice belt module in accordance with a first embodiment of the present invention;

FIG. 5 is a sectional side view on line 5 5 of FIG. 4, on a larger scale;

FIG. 6 is a plan view of brattice belt modules in accordance with FIG. 4, assembled to form a section of belt;

FIG. 7 is a diagrammatic side view showing a brattice belt in accordance with FIG. 6 engaged with drive sprockets;

FIG. 8 is a side view showing the engagement of part of the brattice belt with a drive sprocket, on a larger scale;

FIG. 9 is a plan view of a brattice belt module in accordance with a second embodiment of the invention;

FIG. 10 is a section on line 10-10 of FIG. 9;

FIG. 11 is a diagrammatic side view showing a brattice belt in accordance with FIGS. 9 and 10, with a drive drum; and

FIG. 12 is a cross-section on line 12-12 of FIG. 10.

### BEST MODE FOR CARRYING OUT INVENTION

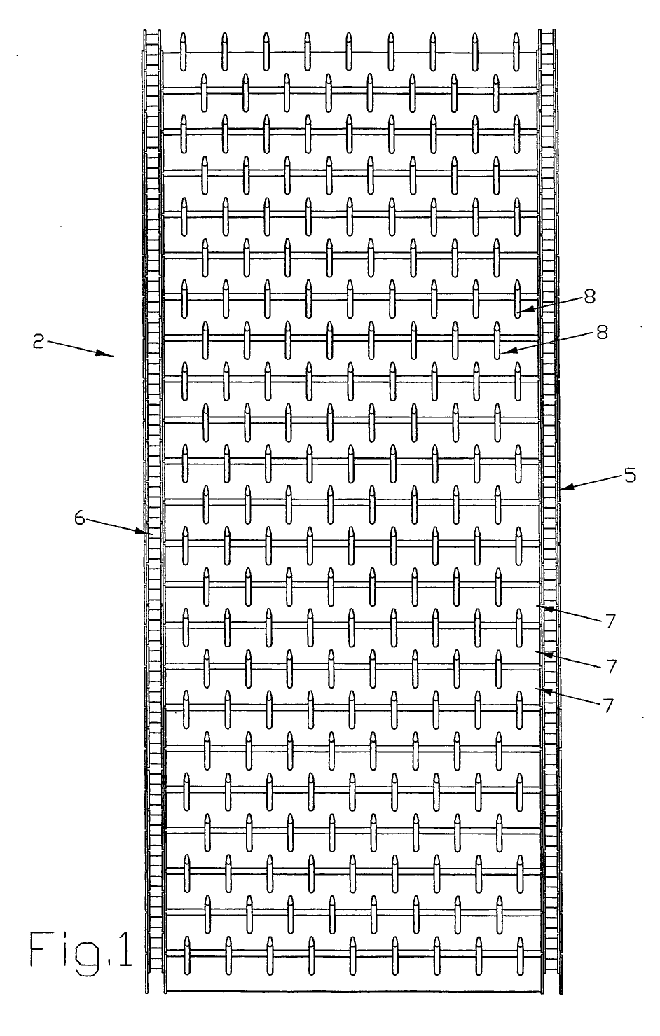

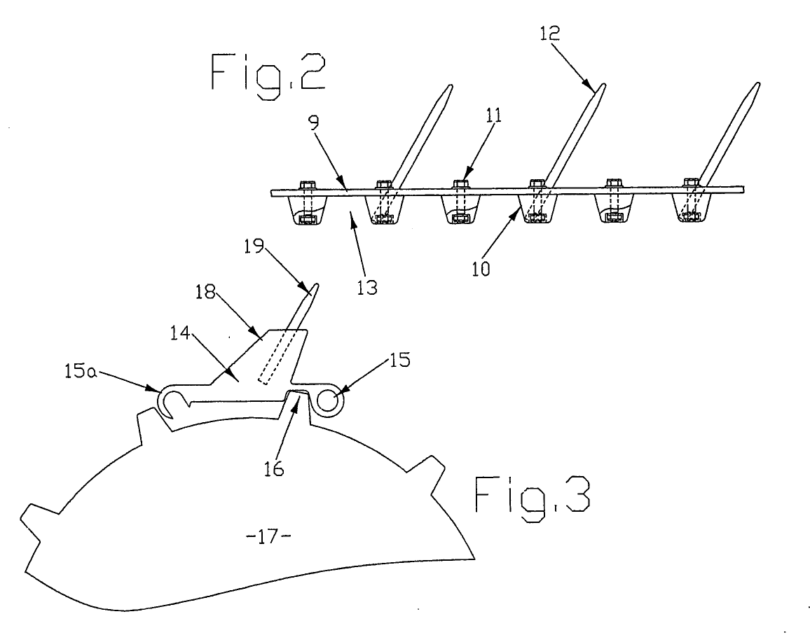

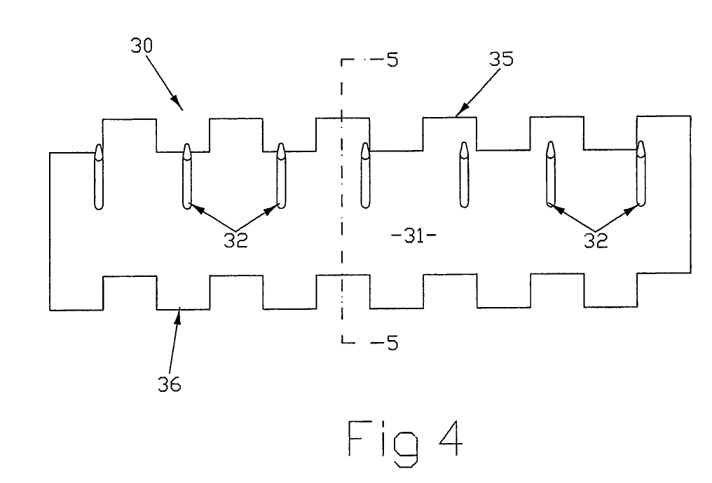

Referring to FIGS. 4 and 5, a brattice belt module 30 is moulded from a suitably flexible, tough, impact and abrasion resistant plastics material. One suitable material is polyurethane with Durometer in the range 80-95 Shore A.

Each module 30 provides a smooth upper surface 31 from which a pin 32 protrudes at an acute angle a (typically about 60 degrees) to the surface. Each pin 32 is made of stainless steel or plastics and is moulded into the module, with the base 33 of the pin encapsulated in a rib 34 formed on the underside of the module.

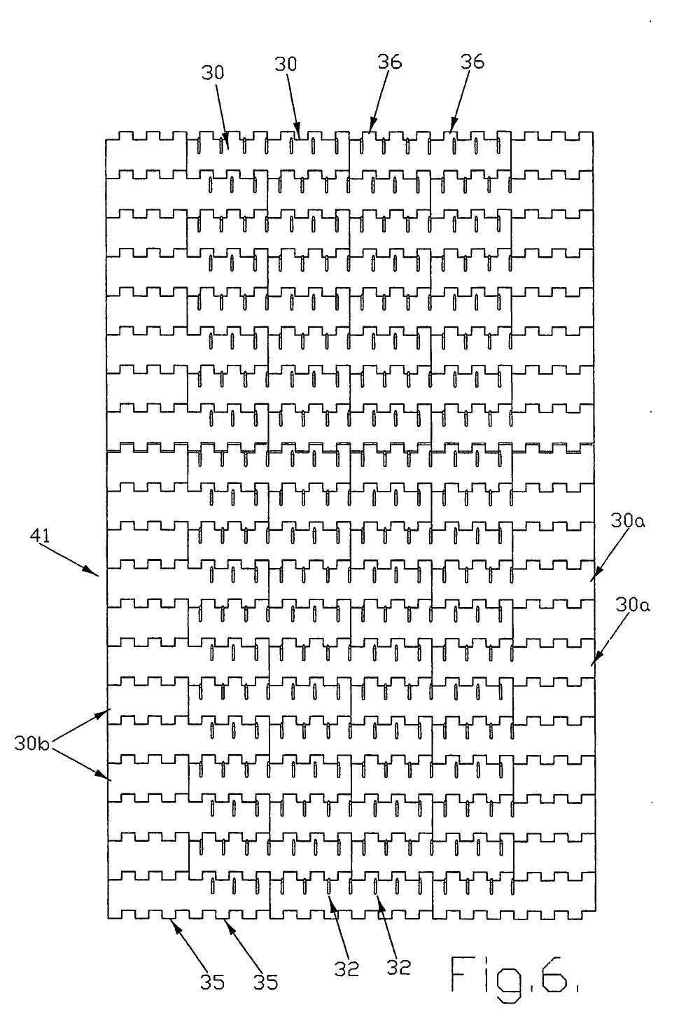

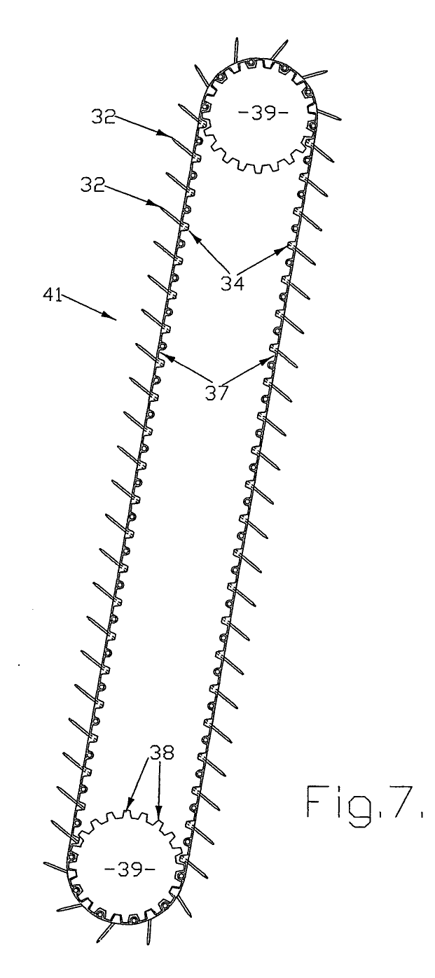

The rib 34 is equidistantly spaced between hinge bosses 35,36 formed along each edge of the module 30. The sides of the rib 34 and the edges of the bosses 35,36 together form the sides of a pair of parallel indentations 37 which extend down the length of each module. Each indentation 37 is dimensioned to engage the teeth 38 of a drive sprocket 39. As shown in FIGS. 7 and 8, each indentation 37 receives a sprocket tooth, and each rib 34, and each boss 35,36, engages one of the indentations 42,43 between the socket teeth. The indentations 37 also contribute to the flexibility of the module.

The hinge bosses 35,36 extend outwards from each edge of the module (see FIG. 4) to form a castellated edge, with the row of bosses 35 along one edge staggered relative to the row of bosses 36 along the opposite edge.

Modules are made to a standard length (e.g. 300 mm) and if a wider belt is required, modules are butted together side by side.

The gaps between adjacent bosses along each edge are slightly larger than the width of the bosses, so that each module can be joined to the preceding and succeeding modules in the belt by inserting the hinge bosses along each edge of the first module into the gaps between the hinge bosses along the opposite edge of each adjacent module. The modules are hinged together in this position by inserting a hinge pin 40 through the aligned apertures of the bosses. The hinge pins are retained by internal protrusions formed in the end boss apertures of the end modules.

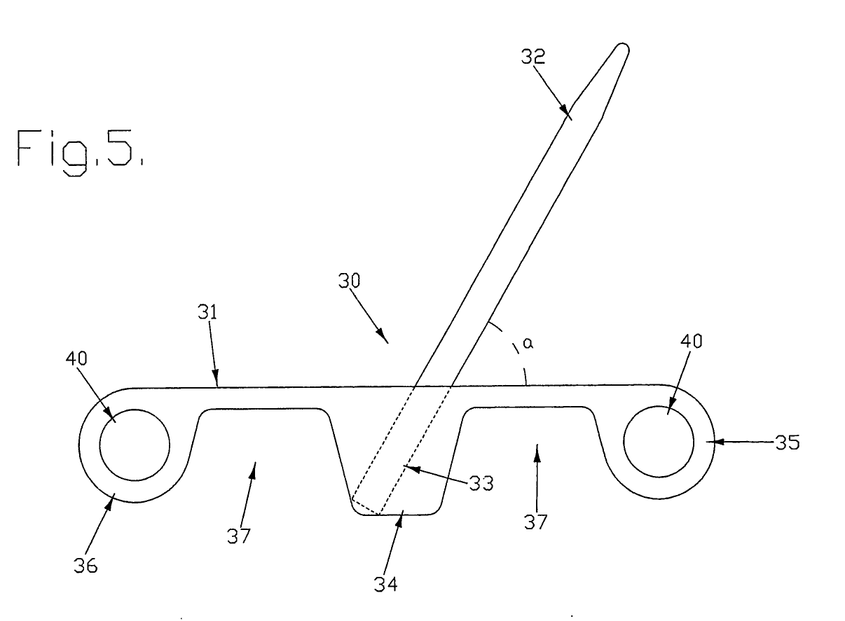

As shown in FIG. 6, many rows of modules are assembled in this way to form a completed brattice belt 41 (a closed loop) of the required length. The modules are assembled in a “brick” pattern, so that when assembled, each row of pins 32 across the width of the belt is half-pitch out of line with the immediately succeeding and preceding rows. In use this means that material missed by one row of pins tends to get caught by the next. Modules as illustrated in FIGS. 4 and 5 may be used for the whole of the belt or, as shown in FIG. 6, the longitudinal edges of the belt may be formed from right-hand and left-hand modules 30a/30b, at least the outer portions of which do not carry pins, so that there are no pins along the edges of the belt.

The above described brattice belt is driven by banks of sprocket wheels at each end of the run of the belt, in known manner. As shown in FIGS. 7 and 8, the teeth 38 of a sprocket 39 engage the indentations 37 and the ribs 34 and bosses 35,36 engage the indentations 42,43 between the teeth 38. The indentations 43 preferably are shallower and more rounded than the indentations 42, to accommodate the shape of the bosses 35 and 36.

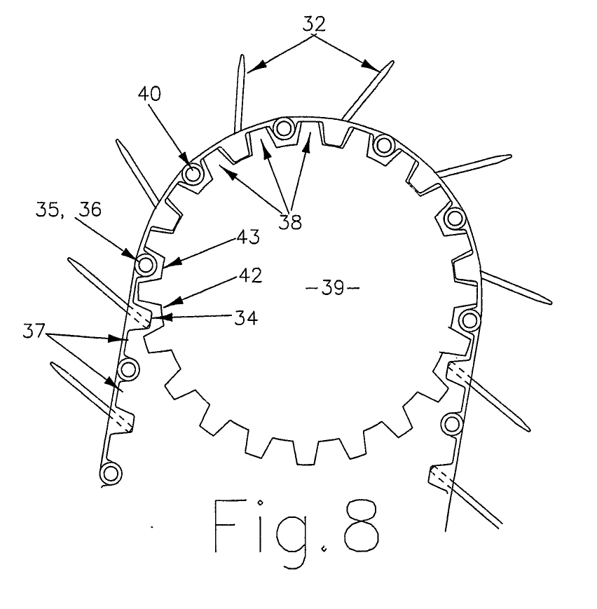

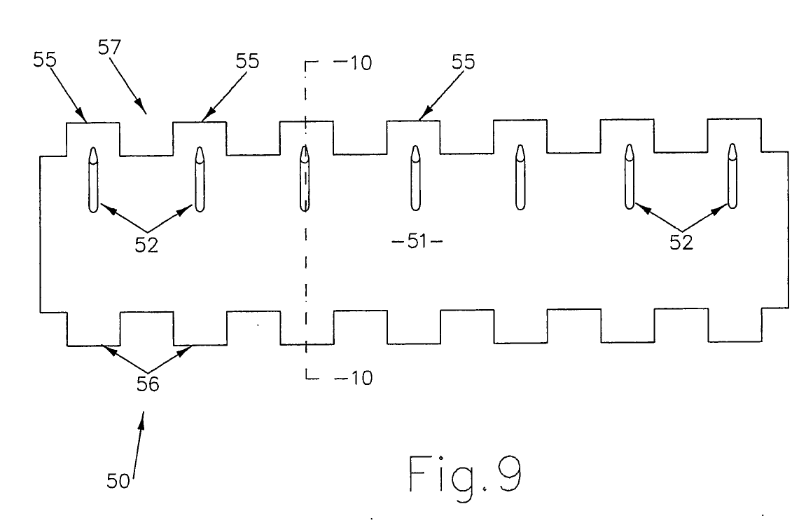

The brattice belt embodiment shown in FIGS. 9-12 is closely related to the embodiment of FIGS. 4-8, but is designed to be driven by flat surfaced drive drums, rather than by sprockets.

As shown in Figs. of 9 and 10, a brattice belt module 50 has a smooth upper surface 51 from which moulded in pins 52 protrude at an acute angle a (typically about 60°) to the surface 51. The base 53 of each pin is encapsulated in a rib 54 formed on the lower surface of the module. The base 53 of each pin is formed with a series of spaced ribs 53a to increase the contact surface between the base of the pin and the surrounding material of the rib 54.

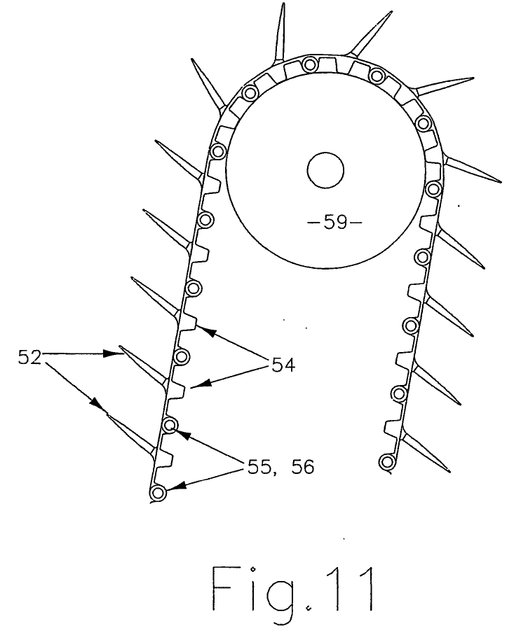

The rib 54 is equidistantly spaced between hinge bosses 55,56 formed on the lower surface of the module. As with the FIGS. 4 to 8 embodiment, the sides of the rib 54 and the edges of the bosses 55,56 together form the sides of a pair of parallel indentations 57 which extend the length of the module. However, whereas in the case of the FIG. 4-8 embodiment, the lower surface of the rib lies in a plane lower than the lower surfaces of the bosses, in the present embodiment the lower surface of the rib 54 lies in the same plane as the lower surface of the bosses 55,56. Thus, when the modules are assembled to form a brattice belt as shown in FIG. 11, and are arranged to pass around a drive drum 59, the drum surface is contacted by the lower surfaces of the ribs and bosses of the belt, maximising the contact area between the belt and the drum.

However, it will be noted that the indentations 57 are suitably dimensioned to engage the teeth of a drive sprocket in the event that the belt is to be used with a drive sprocket instead of a drum.

As shown in FIG. 9, the hinge bosses 55,56 extend outwards from each of the long edges of the module to form castellated edges, with the row of bosses 55 opposite the row of bosses 56. The pins 52 are mounted on the module equidistantly between each pair of opposed bosses 55,56. This is considered to be a superior arrangement to that shown in FIG. 6, since the area of the module between the opposed pairs of bosses 55,56 is the strongest portion of the module.

The above described modules are secured together to form a belt in the same manner as described with reference to FIGS. 4-8, and are used in the same way, except that a belt formed from the modules of FIGS. 9-11 may be used either with drive sprockets or with smooth surfaced drive drums.

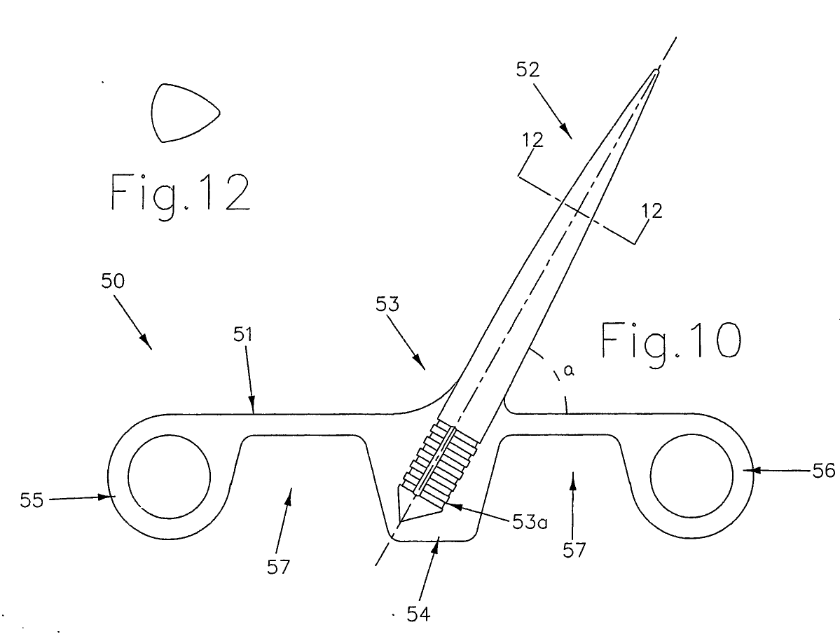

The pins 32, 52, may be of the type shown in FIGS. 4-8, i.e. the circular cross-section with tapered points, or may be of the type shown in FIGS. 10 and 12, with an elliptical cross-section smoothly tapering to a rounded point.

The shape shown in FIGS. 10 and 12 gives maximum penetration into fluffy masses such as wool; this assists with wool teasing and carding. The elliptical cross-section gives a maximum cross-sectional area, and hence a maximum bending resistance whilst retaining a “sharp” profile. Further, the elliptical shape of the leading edge reduces the load on the pin if the pin comes into contact with a foreign object.

In prior art brattice belts, the pins usually were made of steel, because of the comparatively high loading on the pin. In the present invention, although steel pins may of course be used, plastics pins are available as an alternative because the flexibility of the modules greatly reduces the overall loading on each individual pin:—if an individual pin becomes overloaded, the portion of the module to which that pin is attached flexes to allow the pin to deflect and shed all or part of its load. The degree of flexibility of the module is such that the pin can deflect relative to the plane of the belt through at least 20°, preferably 30°, when overloaded.

With the above described design of module, the pin does not bend or break if overloaded:—the overload is accommodated by the flexibility of the module material.

The flexibility of the module material, combined with the hinge connection between each row of modules, means that a belt made up of the modules can “drape” over drive sprocket or drive drums to give a good positive driving engagement.

It will be appreciated that the above-described brattice belt modules are relatively inexpensive to manufacture and are quick and easy to assemble and disassemble. Also, any damaged or defective modules can be individually replaced in the belt.

The fact that the ribs 34,54 lie below the upper surface of the belt means that the module can be designed with a substantially flat outer surface (important to avoid transported material becoming lodged on the belt) but with a comparatively large volume of material holding the pin, so that the pin is very securely held.

1. A module for a spiked conveyor belt, said module being made of flexible material and providing a substantially flat first surface from which protrude a plurality of spaced pins, one end of each pin extending from said first surface with the longitudinal axis of the pin at an acute angle to the plane of hte first surface, the other end of each pin being mounted in a rib formed on a second surface of the module opposite to said first surface, said second surface also providing means for hingedly securing modules together, said securing means being spaced from said rib.

2. The module as claimed in claim 1 wherein said module is substantially rectangular in plan and securing means are provided on each of two opposed edges of said module.

3. The module as claimed in claim 2 wherein each securing means includes a series of spaced bosses each of which is apertured to receive a hinge pin therethrough.

4. The module as claimed in claim 3 wherein the lower surface of said rib and of each of said bosses lie in the same plan.

5. The module as claimed in claim 3 wherein the lower surface of said rib lies in a plane further from said first surface than the plane of the lower surface of said bosses.

6. The module as claimed in any one of claims 3-5, wherein said rib is positioned equidistantly between said bosses and is dimensioned and arranged to engage a drive sprocket.

7. The module as claimed in any one of the preceding claims wherein each pin is made from a material selected from the group: stainless steel, plastics.

8. The module as claimed in any one of the preceding claims wherein each pin is elliptical in cross-section.

9. The module as claimed in any one of the preceding claims wherein all of the module apart from said pin is made from polyurethane with a Durometer reading in the range 80-95 Shore A.

10. A spiked conveyor belt made from a plurality of modules as claimed in any one of claims 1-9, said modules being hinged together to form a continuous loop.

11. A spiked conveyor belt as claimed in claim 10, wherein said modules in the assembled spiked conveyor belt are arranged such that each row of pins is half pitch out of line with the immediately preceding and immediately succeeding rows of pins.

12. A spiked conveyor belt as claimed in claim 10 or claim 11, wherein the modules along the edges of the belt do not have pins immediately adjacent the edge.
